(19) United States
(12) Patent Application Publication
(10) Pub. No.: US 2022/0163018 A1
(43) Pub. Date: May 26, 2022

(54) Gravitational Energy Storage Device

(71) Applicants: Damien Michael Trevor Waller, BRIGHTON (AU); Justin Leigh Ward, Williams Landing (AU)

(72) Inventors: Damien Michael Trevor Waller, BRIGHTON (AU); Justin Leigh Ward, Williams Landing (AU)

(21) Appl. No.: 17/449,318

(22) Filed: Sep. 29, 2021

Related U.S. Application Data
(60) Provisional application No. 63/198,101, filed on Sep. 29, 2020.

(51) Int. Cl. F03G 3/00

(52) U.S. Cl. CPC F03G 3/094

(57) ABSTRACT

A power storage system that uses a plurality of weights, which are raised and lowered in an underground hole, by a motor generator assembly, which is energized to raise the weights thus storing potential energy in the position of the weight, and which recovers energy from lowering the weights as the weights are lowered. A connection assembly, connects between the motor generator and at least one weight; where the connection assembly allows disconnecting a weight from a specific connection assembly, and using the motor generator assembly to raise and lower a different weight once the first weight is disconnected. This enables reusing the moving parts such as the motor generator assembly with multiple different weights.

This application claims priority from provisional application number 63/198,101, filed Sep. 29, 2020, the entire contents of which are herewith incorporated by reference.

### BACKGROUND

Gravitational Energy Storage, also called GES, stores energy via lifting large weights within a shaft.

GES uses off the shelf and proven components, many of which are already being used in industry. These include mine hoist systems, crane systems and winch/generators.

Patent document WO2013005056A1, and WO 20180134620 by Gravitricity, describes using weights in a hole at any given time. This increases the power output.

Gravitricity uses a crane system that stacks weights outside the top of the hole. This increases the energy storage capacity. Gravitricity has certain technology using a compressed air system that increases the power storage of a system that has a single weight in a hole that never comes out of the hole.

Their patented compressed air system also adds complications (eg sealing pressure) and is not required in our systems due to our designs using more of the shaft.

Batteries are another way that energy can be stored on an industrial scale:

Batteries have fast charge and discharge times. They have very fast response times (e.g., milliseconds). However, batteries have low storage capacities (less than 200 MWH). Batteries have high cost per kilowatt hour stored. Batteries also degrade over time. There is a high cost to the environment on disposal of the batteries.

Energy can be stored by pumped hydropower. This is a conventional way to store energy on a large scale. Its advantages include that it is a proven technology that has been around for decades. It has large storage capacities >200 MW.

However, disadvantages include that water is low density, and hence its capacity is limited. This kind of storage has a large environmental cost. The storage depends on rainfall and can be at risk from climate change. It can only be used in limited locations, where the water has a natural location for storage. Building these kinds of energy storage devices can take a significant timeframes of for instance 2-5 years. Since there needs to be a lot of area for storing the water, these can typically be done only at a large distance from cities, requiring a long power transmission.

### SUMMARY OF THE INVENTION

The inventors recognized a number of drawbacks with the current systems.

Embodiments describe storage of energy more efficiently than any storage technology available today. It scales very well and rivals large pumped hydro systems but is much easier to make the overall system.

The technology uses off the shelf components in innovative ways and will last for 50+ years.

Embodiments describe a power storage system that uses a plurality of weights, which are raised and lowered in an underground hole, by a motor generator assembly, which is energized to raise the weights thus storing potential energy in the position of the weight, and which recovers energy from lowering the weights as the weights are lowered. A connection assembly, connects between the motor generator and at least one weight; where the connection assembly allows disconnecting a weight from a specific connection assembly, and using the motor generator assembly to raise and lower a different weight once the first weight is disconnected. This enables reusing the moving parts such as the motor generator assembly with multiple different weights.

Embodiments describe various improvements, including stencil guides in the hole that guide the weights, ways to store the disconnected weights at the bottom of the hole, and ways to store the disconnected weights at the top of the hole.

### BRIEF DESCRIPTION OF THE DRAWINGS

In the Drawings:

The figures show aspects of the invention, and specifically:

FIG. 1 shows an embodiment using long vertical weights held in a hole via stencils in the hole;

FIG. 1A shows a top version of the first version of the stencil;

FIG. 1B shows a second version of the stencil which includes anti rotation capabilities;

FIG. 2 shows a second embodiment using a robotic system;

FIG. 3 shows an embodiment with storage in a nonvertical shaft that is attached at the bottom of the vertical shaft;

FIG. 4 illustrates a plan view of the attachment to the weights in the FIG. 3 embodiment;

FIG. 5 shows an embodiment where the shaft has large storage for weights along the continuous rail;

FIG. 6 illustrates a shaft with large storage using cables to raise and lower the weights;

FIG. 7A illustrates a pan view of the weight attachment points for the weights;

FIG. 7B illustrates a side view illustrating weight attachment points for the weights;

FIG. 8 illustrates a motor generator formed on a continuous loop;

FIG. 9 illustrates an attachment mechanism;

FIG. 10 illustrates an embodiment where the weights are placed on a conveyor;

FIG. 11 illustrates an embodiment where a movable system is used to grip both the cable and the weight, and modify its position of grabbing;

FIG. 12 shows an embodiment where the support beam supported by hydraulic cylinders can raise and lower a weight;

FIG. 13 shows a side view of the cantilever-based weight which can be raised and lowered;

FIG. 14 shows a front view of this weight in FIG. 13;

FIG. 15 shows a weight that is raised and lowered on 3 separate it supports.

### DETAILED DESCRIPTION

The present application describes a system using a motor/generator to lift weights to store power and to drop weights to release power.

Throughout this patent application, the terms have the following meanings.

Weight means a mass or structure, preferably made of low cost and highly dense materials.

Typical materials for weights can include steel, compacted iron ore, high density concrete, or other dense material with the cost to weight ratio which is favorable. Embodiments can use combinations of the above aaterials. For example, embodiments can use steel pipes or tanks with iron ore compacted within the steel types or tanks. Embodiments can use steel structures with formed concrete.

Weight energy transfer or WET means a system that converts the movement of the weights into energy or uses energy to move the weights to store the energy, or “charge” the system.

One such system can include cables and winches including associated gearing for moving the weights. In one embodiment, a gearing system is located directly on the weight, turning large gears.

Another weight energy transfer system includes a conveyor belt system, which can be for example split into multiple smaller section to increase the efficiency and loads. This can also use rail systems of one or more tracks, or pneumatic fluid transfer. The system can also use a movable carriage system within a carriage.

A motor/generator MG is the electric power motor generator system which is energized to store the power to the WET system or deenergized to generate power from the WET system.

Tunneling is carried out using modern mining techniques and machinery to evacuate a tunnel. Geoscience tools can be used to select the optimum location for the apparatus. For example, it is most advantageous to make the tunnels through soft rock to minimize the tunnel costs. However, the soft rock should not be so soft as to cause well wall instability.

The shaft is formed within the ground as deep and wide as possible using blind sinking or another technique to find the bottom. There is a vertical main shaft, and can be, as described herein, additional “daughter shafts” formed by tunneling from the main level of the shaft using raised boring. This can reduce the average cost of the shaft and reduce the cost per cubic meter of excavation. The shaft may also include a non vertical part of the shaft, e.g, a ahorizontal ramp with a decline of for example 15% in some embodiments. In embodiments, the shaft can be a straight line or a downward spiral.

In a preferred embodiment, all of the weights that are used within the system are identical, and hence they can be manufactured using robotic manufacturing methods.

Different features of each of the embodiments can be used with the other embodiments. For example, any of the embodiments can use, as described herein, either cables, or gears to raise and lower the weights, different kinds of shafts, different kinds of connections, and other aspects described in the different embodiments.

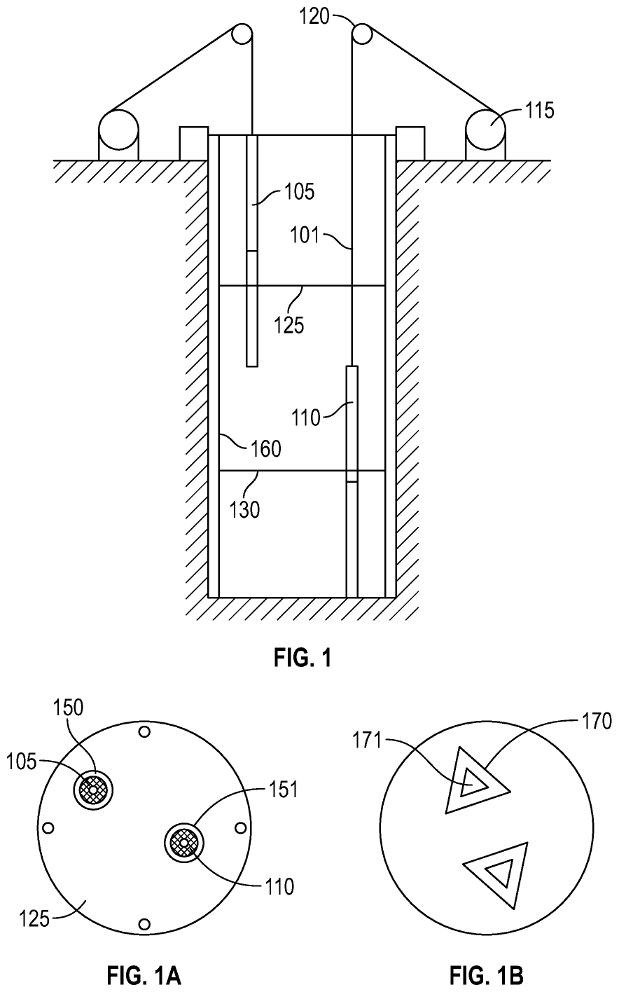

A first embodiment is shown in FIG. 1, and is referred to herein as the long vertical weights embodiment. In this embodiment, each vertical shaft 100 is filled with a number of long slender weights 105, 110. Each of the weights have a cross-section which can be round, square, triangular or custom segmented, to minimize the packing distance between the weightsand hence maximize the stored energy.

One particularly preferred embodiment uses off the shelf steel rods or square billets that are joined into very long weights stored within the shaft on attachments 101, which can be cables or any other kind of attachment mechanism, such as cables or other cord shaped supports that can be raised, lowered and spooled. Each weight, such as 110, is raised to increase their potential energy via a motor generator 115 and lowered to release their potential energy via the motor generator 115. In this embodiment, sheaves 120 are used to allow the motor generator 120 to be connected to the side. The weights in preferred embodiments can be 30 to 50% of the shaft length. Each weight can also be held outside of the shaft which in turn increases the potential energy of the charge.

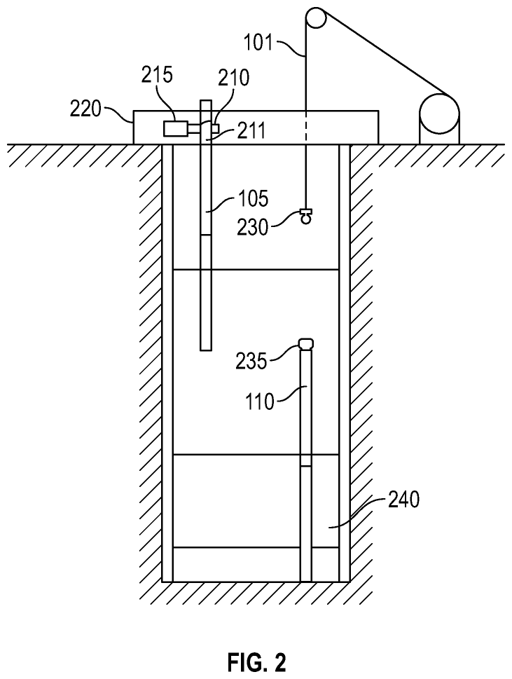

To reduce capital cost of the WET system and MG, embodiments described multiple different weights 105, 110 for each WET and MG combination with a robotic system to attach to the top of each weight before lowering or raising, as shown in FIG. 2. Each rope or cable such as 101 includes an end piece 230 which attaches to a corresponding female version of the end piece 235 located on the weight. In this way, the system can attach to the weights when needed, and detach when not needed. This system can use location sensors, cameras, magnets in order to ensure robust and accurate functioning. The weight, such as 110, can be lowered all the way to the bottom 200 of the shaft, and detached and left sitting at the bottom of the shaft. The attachment to the weights can be, for example, a magnetic attachment to the top of the weight, a hook which hooks into a corresponding hole or tab in the weight, a hydraulic tab that extends into the weight forming a pin in a hole in the way, or any other type of connectable system.

A “stencil” 125, 130 is used in the shaft to keep the weights in position in the shaft. This stencil can be raised or lowered for servicing via a track or other system and has low friction sleeves or bearings. The stencil can also be “keyed” as shown in FIG. 1B so that each long weight will not rotate hence reducing the cost of the ropes. By using the stencils, the weights can be maintained with a known distance from one another, and that distance will maintain all the way from the top of the shaft to the bottom of the shaft, with the weights being held into place by the stencils. The stencils in an embodiment are spaced from one another by a distance less than the length of the weight, so that each weight will always be guided by one stencil or 2 stencils.

In an embodiment, the stencil, 130 has holes which hold the weight 110 in the upright position when the bottom of the weight is leaning against the bottom 200 of the shaft.

FIG. 1A shows a plan view of the stencil 125, showing how that stencil has openings 150, 151 which respectively hold and guide the weights 105, 110, as they pass up and down through the shaft. FIG. 1B shows the plan view of the stencil which is keyed for a triangular weight, where the triangular weight 171 is held within the stencil hole 170. However it should be understood that many other shapes can be used to prevent the rotation of the weights relative to the stencil, including square and other shapes.

Power is stored when all the long thin weights are hanging at the top of the hole. When held at the top of the hole, the weight, such as 105, can be held in place by a pneumatic/hydraulic pin 210 which is extended and removed by a hydraulic actuator 215. The pin 210, if used, extends into a corresponding hole 211 in the weight. The pin and actuator are connected to a structure 220 which sits at the top of the hole, and forms a top structure for the housing. Once the weight is held at the top of the hole, it can be moved out of the way of the top of the hole or maintained at the top of the hole.

When held at the bottom of the hole, the weight is simply disconnected, and held upright by the stencils. One or more bottom stencils 240 are located in a position to hold the weights more effectively.

This embodiment discharges its energy by dropping weights to the bottom of the hole. At the bottom of the hole, the weights rest on the bottom of the hole, or hang from the ropes, or both.

To charge the system, the ropes and weights are pulled to the top of the hole. They either hang attached to the ropes or are attached to a structure such as 215 at the top of the hole.

For larger systems, the robotic system shown in FIG. 2 connects and disconnects the weights from the ropes at the top of the hole. At the bottom of the hole there is a release mechanism to separate the weight from the rope/cable 101, so that the same robotic system can be used to charge and discharge additional weights.

An important feature of this embodiment, is combining off the shelf heavy components into a number of very long rods/beams, for example by using steel rods and beams. This ensures that a very large aggregate weight can be used and that each individual weight can be raised and lowered by existing off-the-shelf components.

Stencils are used to keep these weights in place and in an embodiment to stop rotation via a key mechanism.

Ensuring the weights are a large percentage of the shaft e.g. 30-50% of the shaft to optimize for lower cost and higher power. Most other systems use very short weights when compared to the length of the hole.

The Robotic system can be used in an embodiment to connect and disconnect to each weight before and after lowering.

Blind sinking a hole is an expensive exercise. Additional holes can be made with the raised bore technique which is significantly cheaper than the blind sinking technique. This reduces the cost per kilowatt of storage.

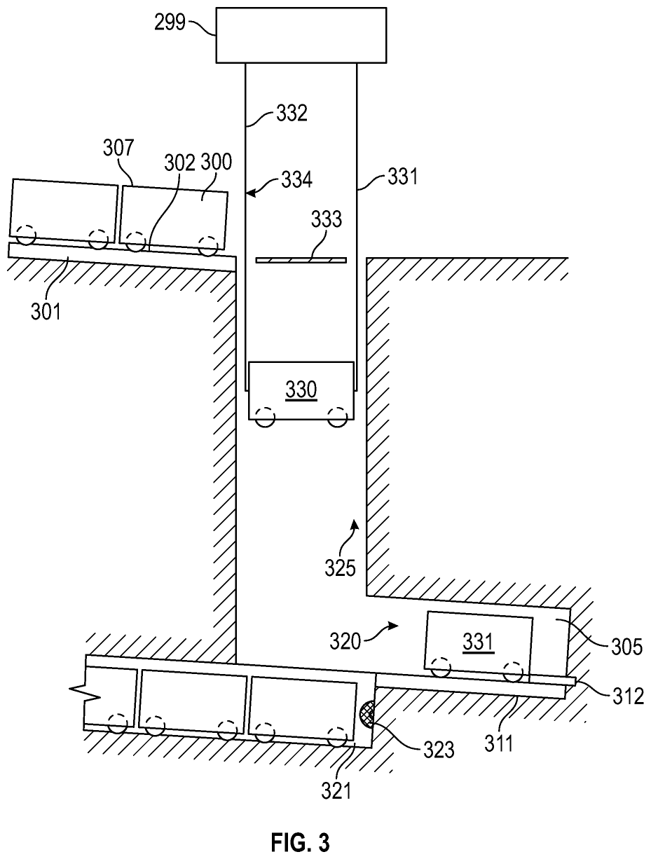

Another embodiment, called the “shaft with large storage”, is shown in FIG. 3. In this embodiment, a significant number of weights are stored above ground at the above ground level 307, and also at the base level of the shafts 305. Weights, however, are not stored in the shafts. The weights are stored on a conveyor or “train” 300 or similar system on tracks 301 with wheels such as 302 that travel on the tracks 301 to ensure efficient and virtually unlimited numbers which can be “Queued” ready to be lowered to generate power or raised to store power. The weights which are in wheeled in this way can be referred to herein as weight carts. Weights are moved up and down the hole via a WET system using the cables 331, 332 2 raise and lower the weight carts. At the top, the weights can be located on to an expanding track part 333, and wheeled in the direction 334 to store the weights in locations such as 300. At this point, the cables are released from the weight carts, and can be used to raise and lower other weights. At the bottom, the cables are again released, and the weights are moved in the direction away from the bottom of the hole for storage. At both top and bottom, the weights are moved horizontally or close to horizontally once they are in their final positions to be stored.

The tracks 301 at the surface may decline toward the hole to allow for gravity based movement of weights and avoid the need for powered movement.

The tracks 311 at the base may decline away from the hole to allow for gravity based movement of weights and avoid the need for powered movement.

At the bottom of the underground storage area there is a braking system 312, such as but not limited to a hydraulic/pneumatic system to decelerate the carts at the end of the track. A conveyor system may not need braking.

Once the carts, such as 310 have been stored at the bottom of the track, there can be an energization system, such as a gear to move the cart into position where it can be attached by the cables 331, 332 and raised to store energy.

Virtually unlimited weights can be stored both above ground and below thereby significantly increasing the energy storage. In addition, this system will ensure the weights do not fill up the shaft at the base which means even more power can be stored and extracted thereby reducing the cost per KW of the system.

This system uses much simpler, less costly rail or conveyor systems that move weights to and from the top and bottom of the hole.

Horizontal tunnelling is significantly less expensive than vertical tunnelling. The horizontal tunnel 320 attaches to the vertical tunnel 325, and this horizontal tunnel 320 can store the weights once released and keeps the vertical tunnel 325 free of weights and significantly reduces the storage cost.

The storage system above and below the shaft, if on a meaningful decline can also add to energy storage.

If a cable hoist is used as opposed to a conveyor, at least two weights at a time can be lowered or raised to ensure continuous power storage or output.

As the weight passes the top of the hole, a hook is attached to the weight. The hook is attached to a cable attached to the MG. The hook can move the weight onto the expanding track, and push the weight off for storage. When the weight gets to the bottom of the hole, a mechanism detaches the hook as previously described.

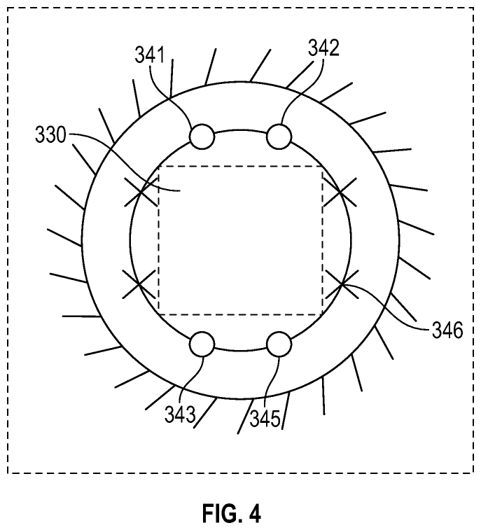

FIG. 4 shows a plan view. This shows the weight, 330, attached to cables such as 331, 332 at attachment points 341, 342 on one side and 343, 345 on the other side. There also can be additional attachment points, such as 346 in the event heavier weights are used or more cables are desired.

In operation, the system is charged when all weights are on the rails/conveyors at the top of the hole. To discharge the system, the weights roll down the rails/conveyors under the force of gravity and are loaded/attached to the hoist or WET 299. The weight is lowered down the hole and the energy collected via motor/generators. At the bottom of the hole the weight is released onto a conveyor or track 311 that allows the weight to move away from the bottom of the hole into the tunnel 320 under the force of gravity. The cart is stopped or slowed down at the end of the track by they hydraulic speed supressing system 312. In one embodiment, the week carts such as 331 are stored on this declined track which extends a distance. In the embodiment of FIG. 4, the incline track extends in a circle back to a point 321 a little lower in the hole. A stopper 323 is located at the end of the hole, to absorb any force from the weight cart.

The weight and WET is designed to move multiple weights within the hole at any given time.

To charge the system, the weights are collected by the WET from the bottom of the hole. The track for the weights landed on at the bottom of the hole receives those weights.

When the weight gets to the top of the hole, the movable rail 334 moves into place under the weight before it is released from the ropes, or the weight can be moved vertically at the top, to move it onto the rail. The weight is then It is pulled upslope via a pulley system and held at the end of the conveyor/track.

Important features of this embodiment can include the following. An embodiment can use high density material such as concrete as the weight, or using using crushed iron ore as the weight.

A mechanized conveyor or train system is used above and below ground to store large numbers of weights and move them to and from the loading points.

Alternatively, an above ground crane system can be used to move the weights to and from the loading points.

An embodiment describes tunnelling horizontally at the base of the shaft to allow the weights to be raised and lowered the full length of the shaft. This results in huge storage capacities.

The tunnel at the base declines away from the hole and the conveyor/rail system above ground decline towards the hole. Hence no power is needed while discharging the system.

The lower tunnel can curve around and end up at a location near the bottom of the hole, at a height below that bottomr.

The speed supressing system, which can be pneumatic or hydraulic, can stop and stack the carts at the end of the above and below ground tracks/conveyors.

The hoisting system and weight attachments that allow multiple weights to be moving in the hole at any given time.

A movable rail mechanism can be used that widens that track to allow the weight to pass through.

Blind sinking a hole is an expensive exercise. Additional holes can be made with the raised bore technique which is significantly cheaper than the blind sinking technique. This reduces the cost per kilowatt. Connecting the generator cable to the weight on the fly (while weight is moving), and disconnecting the generator cable from the weight at the bottom of the hole on the fly (while the weight is moving) can use a Roller coaster style track

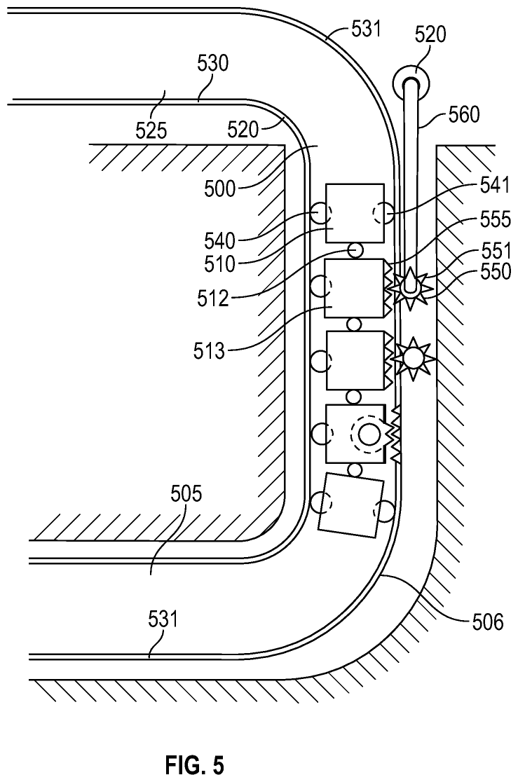

Another embodiment, shown in FIG. 5, is called Shaft with Large Storage with Continuous Rail.

In this embodiment, a number of weights are located in a horizontal shaft, which connects at the bottom to a horizontal portion 505. In this embodiment, there is a curved area 506 interfacing between the vertical portion of the shaft and the horizontal portion of the shaft. The weights comprise a number of connected weight parts, such as 510, 513, connected by a connection part 512 which allows hinging between the weight parts so that they can extend around the curve shown as 506. In a similar way, the above ground or top portion of the shaft has a curved portion 520, which leads to an above ground horizontal portion 525 allowing storing the weights above the ground.

Because of the curve, the storage for the weights at the bottom of the shaft is continuous, that is the weights need not be connected or disconnected.

The shaft and storage in this instance may be one long spiral ramp at a decline as in FIG. 3.

The rail could be one or many and in multiple dimensions. In one embodiment, the weight is square and has rail attachment mechanism is attached to each corner.

The weights are raised and lowered into the shaft via the WET system. This system can use any of the previously described raising or lowering techniques, and can also use a gearing system as shown herein.

The carriages are designed to maximise storage density in the form of distance from one to the next and also take up as much of the shaft cross section as possible.

Each carriage is designed to deal with curved tracks in order to descend into the hole and to turn corners.

The tracks at the top and the bottom can spiral away from the hole and therefore reducing surface area used by the system.

In operation, the weights 510, 513 are joined together in one long train. The system is charged when the train is on the above ground horizontal 525 (or gently declined toward the hole) portion of the track. The center of gravity of the system is such that the train will move down the hole when braking systems are released.

Once the braking systems are released, the train moves down the hole on tracks under the force of gravity. The weights, such as 510 have wheels 540, 541 which respectively run on the tracks 530, 531. Energy is collected from the system using the WET.

The train is articulated and it can bend down the hole and bend away from the bottom of the hole. As the front of the train approaches the end of the underground horizontal section of track, the front is slowed via a speed suppressing system.

To charge the system, the train is moved up the hole by the WET. The system is fully charged when it is at the end of the track at the top of the hole.

This embodiment has the following benefits.

The entire hole can generate maximum power as the weights take up the entire space.

This embodiment shows using a gearing system 550 to raise and lower the weights. The gearing system includes an rotating gear 551 which connects to respective geared shaped portions 555 that are on one side of the weight. There can be one or many of these gears. The gearing system 551 is connected to a chain 560 which connects to the surface generator 570. Alternatively, this can use a similar chain or rope system to that in the previously described embodiments.

The length of the train very long, and hence large amounts of power can be stored.

The power output of the system is extremely large and can be controlled up and down as required by changing the velocity of the system, with higher power output at higher train velocities. Power extraction can also be carried out at very low velocities reducing wear and tear on the system.

This embodiment can use connected train carriages as a very long continuous weight.

Using gearing at the base of each carriage to drive MG. Alternatively, cables could be used to drive the MG or the MG's could be in the weights themselves.

Storage of the trains in a spiral in order to minimize land area use.

Tunnelling horizontally at the base of the shaft ensures huge storage capabilities and maximizes the full length of the shaft.

Tunnel at the base can be at a decline away from the hole to increase storage capacity in embodiments.

Track at the top of the hole is on a decline towards the hole to increase storage capacity and to overcome friction when discharge begins in embodiments.

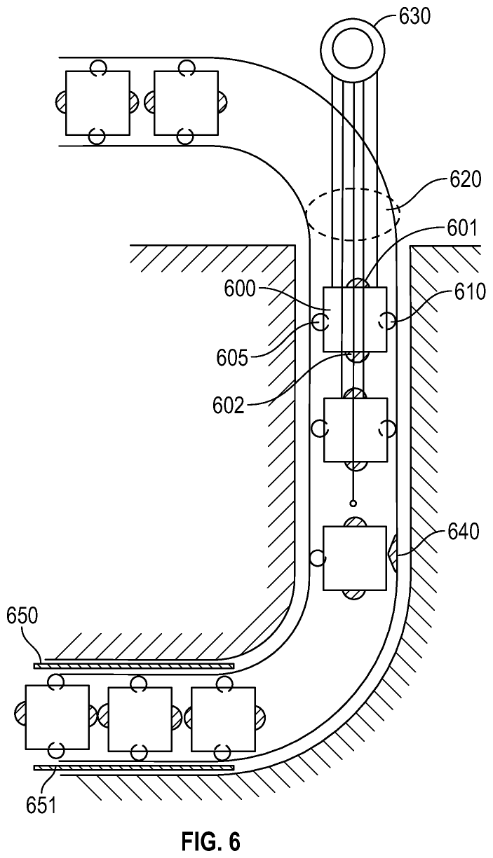

FIG. 6 shows another version of the shaft with large storage, using cables. This embodiment, uses a similar style weights to those in FIG. 5, where each weight 600 has rollers 605, 610 which respectively roll on tracks. However, these weights are connected to cables 620, which themselves connect to the motor generator winch 630 which stores and recovers the energy. The weights such as 600 include bumpers 601, 602 to absorb at least some of the kinetic energy if the weights contact one another. As in the other embodiments, a pneumatic speed suppressor 650, 651 can be located at the bottom of the hole to slow down the weights at their terminus.

In this embodiment, the weights can include a weight release trigger 640, at a spot near the bottom most portion of the vertical portion of the hole. The triger can open a hook holding the weights, so that the weights can be automatically released at the vertical at that portion near the bottom most portion of the hole.

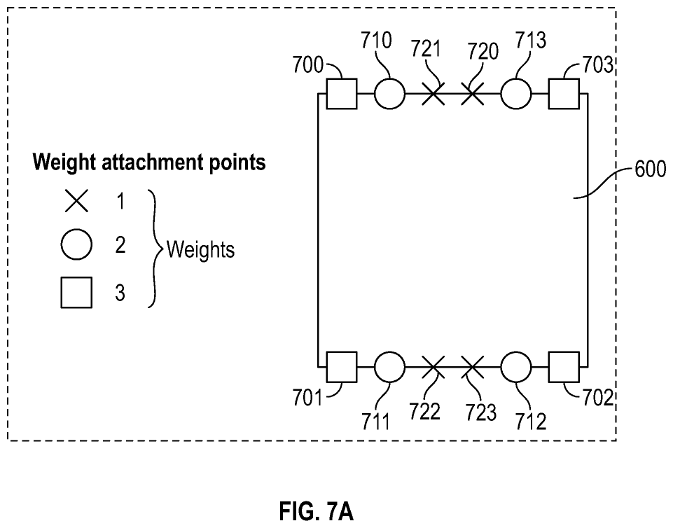

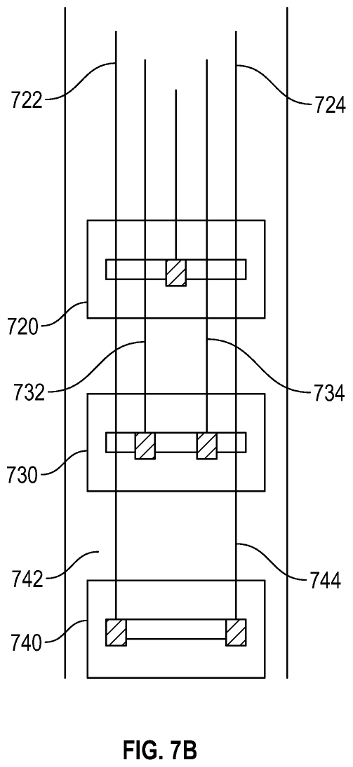

FIG. 7 illustrates a plan view showing the top of the weight such as 600, and showing the attachment points at the top of the weight. The different weights can be attached at different points, allowing the cables to not interfere with one another. A first set of attachment points can include 700 701, 702, 703. A second set of attachment points for a different set of weights can include 710, 711, 712 and 713. A final third set of attachment points for the center parts of the weight can include 720, 721, 722, 723.

FIG. 7B illustrates how the different weights such as 720 can be connected to the cables 722, 724 and those cables 722's, 724 extend towards a central area of the bore. The weight 730 can be connected to cables 732 734 which are in different locations in the bore, more outward towards edges of the bore than the cables 722, 724. The weight s 740 can be connected to cables 742 744 which are even further towards the edge of the board, and again non-co-located with the first set of weight any of the other cables that are used.

As in the previous embodiments, the system can attach and detach weights, the weights being detached at the bottom of the hole and at the top of the hole, and attached to the motor generator 630 in order to either charge the battery or discharge the battery.

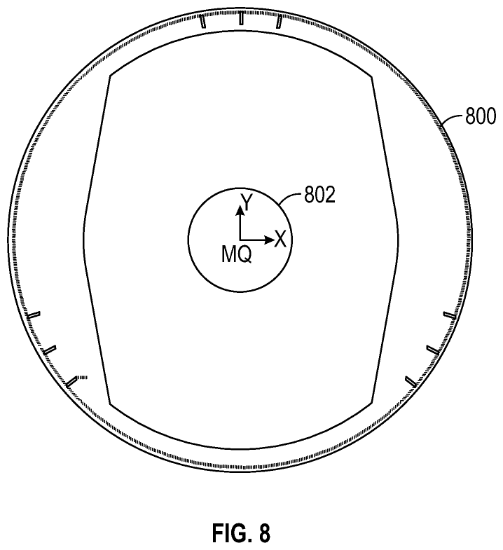

Yet another embodiment allows the system to be carried out using a conveyor. The conveyor as shown in FIGS. 8, uses a continuous belt that loops around the motor generator 802. The belt 800 can be formed of any rigid material, such as carbon fiber, metal, other fiber, or other any other strong belt material. Weights can be held at various locations on the track.

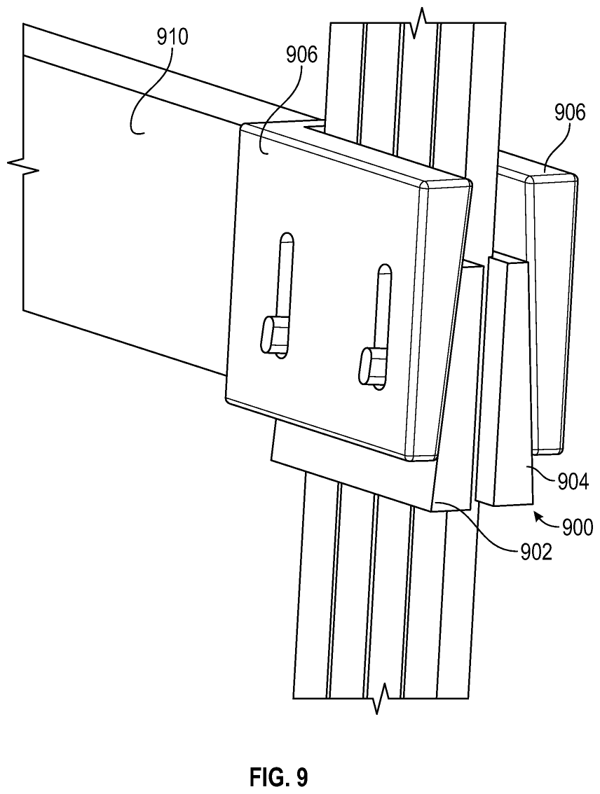

In one embodiment, the friction wedge 900 is shown in FIG. 9 can be used to hold the weights on the track. This uses wedge-shaped pieces 902, 904 held by screwed in covers 906, 908, to hold to the weight 910 or weight connecting element.

In another embodiment, another compression device can be used to hold the weights on the track. The weights can be added to or removed from the track by robotic devices, as explained herein.

Moreover, a number of these units can be provided one next to the other, by rotating each assembly around the vertical axis to provide a number of assemblies that operate in parallel with one another.

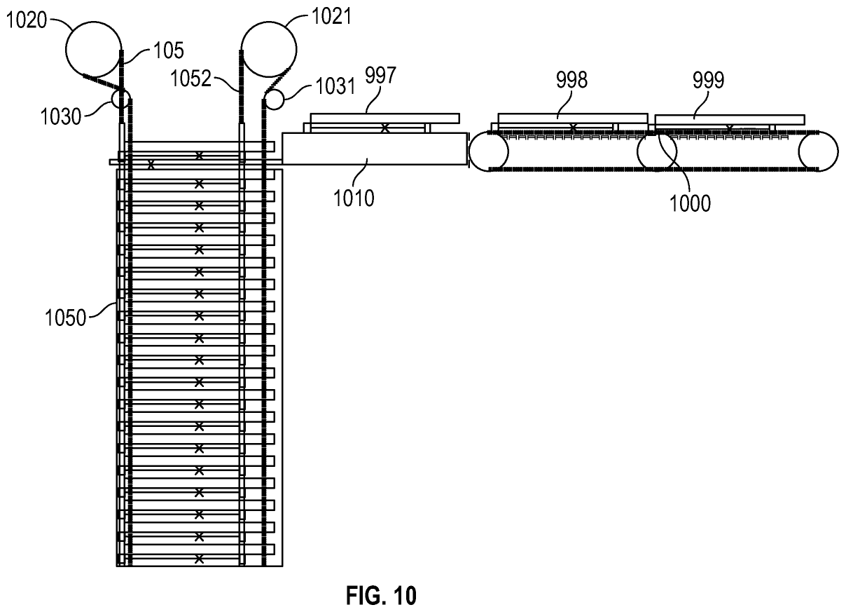

FIG. 10 illustrates another embodiment which uses weights 997, 998, 999 which can be stored in the horizontal location, and moved to the shaft, e.g. a vertical shaft 1050, via the conveyors. In an embodiment, there is a fixed speed conveyor 1000 connected to a variable speed conveyor 1010. This allows matching the shaft speed to allow attaching mass to the cables which are lowering at shaft speed plus the engagement speed. Using 3 pulley assemblies provides enough side space to insert the weights through the belts.

A drive pulley 1020 can connect these weight assemblies via an guide pulley 1030 on one side, and a second side drive pulley 1021 connects via a guide pulley on the other side. The drive pullies can be the motor generators, or can be attached to the motor generators in different embodiments. In this way, the weight assemblies can be placed on and off the track to be raised and lowered as desired. The guide pullies pass the unloaded belt back and out of the way on it's return journey.

A robot arm (or simpler hydraulic robot) picks up the weights from the conveyor 1010 and moves them to the shaft 1050. The robot lowers the weight faster than the speed of the belts on the pulleys and rotates the weight to lock it on to the belts. In one embodiment, there is an attachment point on the top center of the weight.

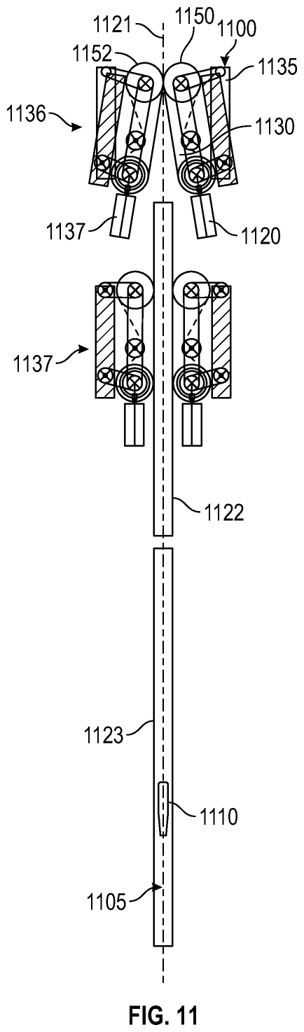

FIG. 11 illustrates an embodiment, usable with any of the other previously described embodiments, showing a motor and disjoin system for cable and weight raising and lowering. A cable 1121 is attached to one or more weights 1122, 1123. These weights are for example in a shaft as previously described. The conveyor assemblies, such as 1100, can connect to both the cable 1121, and to the weights 1122 to raise and lower the weights using 4 bar linkages to provide clamping force and a wedge angle for loading on the beam. A drive motor 1120 creates force, which is linked to the front drive part 1150. There is a corresponding drive motor 1151 and drive part 1152 on the conveyor part on the opposite side of the cable 1121. The drive motor creates its energy, and passes that to the friction belt 1130 contacting the shaft wall being. This allows for gaps in the beams, surface roughness, and other imperfections while still provides friction to run the system.

Moreover, this system uses a spring biased connection, so that the drive parts 1150, 1152 can be separated in locations where they need to connect to a way which is thicker than the cable.

The linkage attachments 1100 each are attached to drive motors 1120, which can be part of the motor generator assemblies.

The drive motors run a friction belt 1130 contacting the shaft 1105 and a beam. This allows for gaps in the beams, surface roughness, and friction to drive the system. There can also be a structural beam 1135 supporting the mass. This allows changing using the motors to change the position on the beam, between off the beam as in 1136, and on the beam, thus supporting the mass as in 1137.

A support rail disjoin 1110 forms an attachment point to the next shaft segment. This is a ferrule that attaches to the next segment as needed.

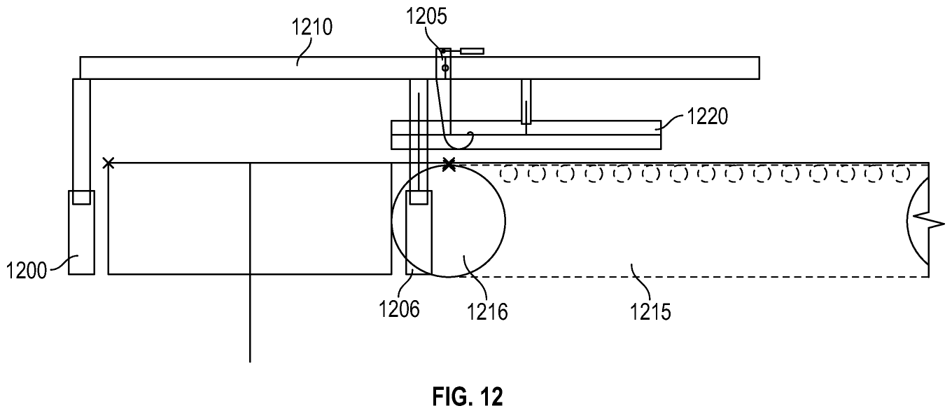

FIG. 12 illustrates another embodiment which allows lifting and moving the masses and attaching them to a new support once moved.

Support beam 1210 that slides across the shaft supported on sides by hydraulic cylinders such as 1200, 1206 to allow for vertical movement. The hydraulic cylinders raises and lowers the beam 1210. When lowered, a lifting hook can lift the mass 1216 off the storage conveyor 1215, and place that mass 1216 onto the shaft. The mass 1216 attaches onto the shaft 1210, and is held into place. Once attached onto the attachment point 1220, the mass is held on the shaft.

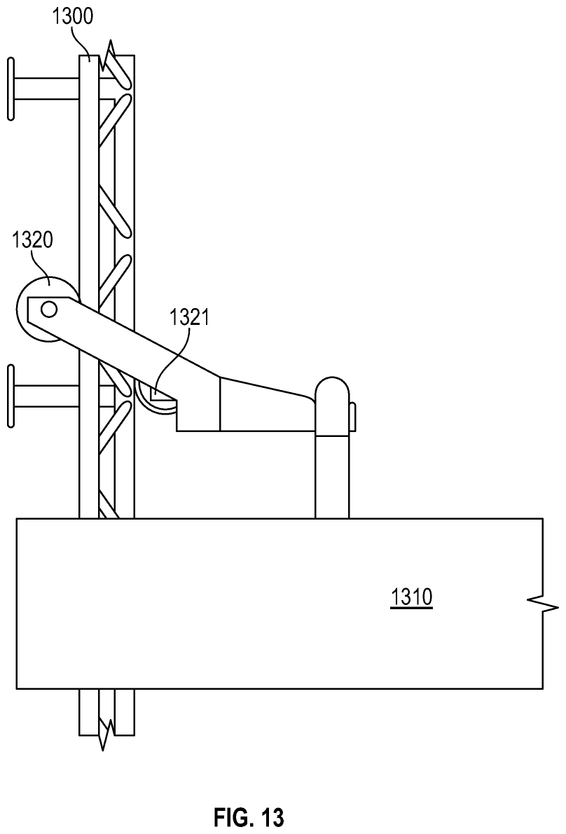

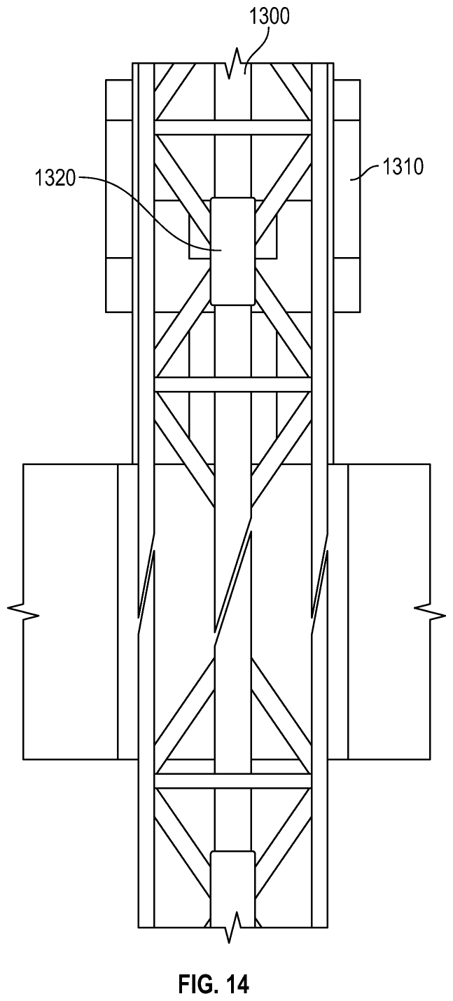

FIG. 13-14 illustrate a mass moving system operating using a gondola system. The gondola operation has tracks 1300 down the side of the shaft. The weights such as 1310 can travel along those paths. One or more tracks may be attached to the side of the shaft. Sets of wheels 1320, 1321 facilitate the weight 1310 moving up and down the track. The wheels are located on the track, with first wheel 1320 on one side of the track, 1300, and the other wheel 1321 on the other side of the tracks 1300. The rotational force caused by the off-center weight clamps the wheels to the track. This ensures a rolling motion, rather than a sliding and minimal friction motion. The rolling motion can cause forces the rotational force to the reversible and removable motor generators.

As an alternative to the multiple wheels and off-center structure, springs, hydraulics, or a clamping mechanism may put sufficient pressure on the rails to gain the traction.

FIG. 14 shows the gondola from a front end view, relative to the tracks.

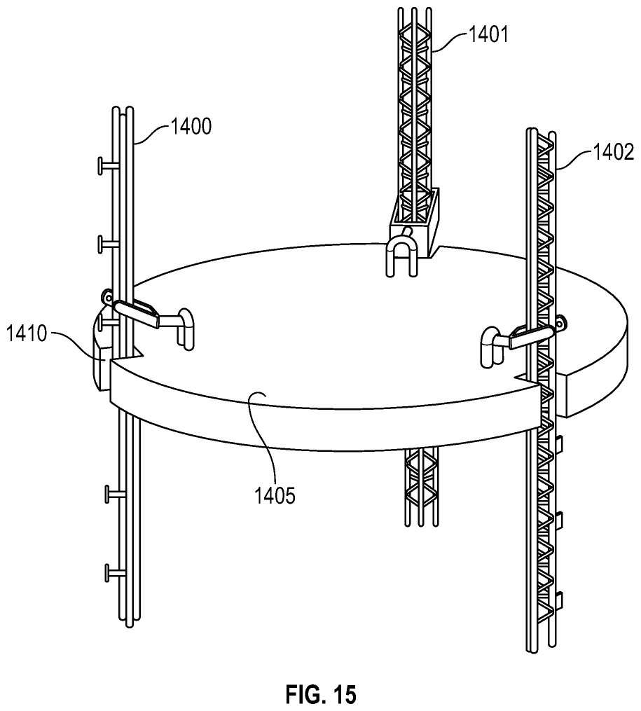

In another embodiment, usable with any of the previously described embodiments shown in FIG. 15, an assembly is formed from one or more sets of tracks with weights, in this embodiment, 3 tracks 1400, 1401, 1402 support a weight in the center, By using multiple different tracks, such as shown in FIG. 15, where there are 3 sets of tracks 1400, 1401 and 1402, a larger weight 1405 can be formed from each assembly. By use of multiple assemblies, this allows for increased power output or charging rate as there are more weights in the hole at any given time. The motor/generator can be removable from the weight, making the system modular.

In this embodiment, the weight is a large disc-shaped weight which is supported on three sides. The disc-shaped weight has indents such as 1410 allowing the support 1400 to pass through the indent 1410.

In different embodiments, there can also be multiple different modifications allowed, as described herein.

The MG can also be in the wall in another embodiment. Those weights could be solid weights. When using MG in the wall, there could be tens, hundreds or thousands of MG powered wheels in the wall of the shaft. In one embodiment, those wheels may be in a checkerboard pattern on the sidewall. A mechanism pushes the wheel against the weight in order to grip the weight. This mechanism may be, for example, a self locking lever arm. The mechanism and wheel assembly can be locked into a recess, and can be unlocked from the recess in order to perform maintenance on the wheel assembly.

In different embodiments, because the weights are stored within a deep hole, depleted uranium or other nuclear materials can be used as the weights. As these materials are heavy, they would be ideal potential energy stores. This also has the advantage of storing these materials underground, e.g., in a deep mine shaft

The apparatus could be used to rehabilitate disused mines or mines nearing end of life.

The apparatus could be used to contain underground laboratories such as neutrino observatories.

The apparatus could be used to add value to existing mining and exploration efforts.

The apparatus could be used to extract hydrothermal energy.

Advantages of certain embodiments include the following.

For the embodiments describing Long Vertical Weight(s), Off the shelf steel products can be used. Off the shelf motor/generators, drums and cables can be used. A very large heavy weight is split into a number of smaller weights

The thin rods enable very long weights. This allows a large percentage of the shaft to be filled with weights thus increasing the storage density and storage capacity.

Embodiments have the ability to lift all weights as one or individually.

The stencil embodiments ensure the weights do not hit the sides of the shaft and can allow the system to be used in shafts which are not 100% vertical. They also allow many weights to be used in the hole without concern for the weights touching one another.

A robotic system to connect and disconnect to each weight before and after lowering reduces the need to have multiple winches, ropes, generators and other moving parts.

Using a blind sink technique for the main shaft but then creating less expensive raised bore holes around the main shaft to bring down the overall costs.

For a Shaft with Large Storage, high density concrete can be used as the weight. The concrete can be for example scrap concrete such as rubble.

The amount of power stored can be increased simply by adding more tracks and weights at the top and base of the shaft.

While discharging, all weights move downhill on all sections of the system. While charging, all weights move uphill on all sections of the system. This minimizes energy loss.

Tunnelling horizontally at the base of the shaft ensures huge storage capabilities and maximizes the full length of the shaft for potential energy storage.

Utilizing the full length of the shaft dramatically reduces the cost per kwh (less than $60/KWh in some configurations)

Using a blind sink main shaft surrounded by less expensive raise bore holes around the main shaft decreases the cost per KWh.

The tunnel at the base is much cheaper than the more expensive vertical shaft.

Conventional mine hoist systems are used in one embodiment.

Conventional rail systems are used in an embodiment.

Energy output is increased by an innovative system that allows more than 1 weight to be raised and lowered at a time.

For a Shaft with Large Storage+Continuous Rail, the single long train allows for a much greater power output than any other GES system.

The single long train system means that the single weight only needs to be slowed once at the bottom of the hole.

The speed of the system is very low, e.g, 20 cm per second in one embodiment.

Using low cost, but high-density products as the weight such as crushed iron ore, or high-density concrete or other such materials.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A power storage system comprising:
a plurality of weights, which are arranged to be raised and lowered in an underground hole;
a motor generator assembly, which is energized to raise at least one of the weights, thus storing potential energy in the position of the weight, and which recovers energy from lowering the weight as the weight is lowered; and
a connection assembly, which connects between the motor generator and a first weight, where the connection assembly allows disconnecting the first weight from the motor generator assembly, and attaching the motor generator assembly to a a second weight and using the motor generator assembly to raise and lower the second weight once the first weight is disconnected.

2. The system as in claim 1, further comprising a plurality of stencil guides in the hole, the stencil guides guiding edges of the weights, to raise and lower the weights along specified paths through the hole defined by the stencil guides.

3. The system as in claim 2, where the weights are disconnected at a bottom of the hole, to rest against a bottom surface of the hole, and be held upright and in position by the stencil guides.

4. The system as in claim 2, where the stencil guides maintain a rotational position of the weights and prevent rotating of the weights.

5. The system as in claim 1, where the connection assembly includes a first disconnection part which enables disconnecting the weight at a bottom of the hole, and a second disconnection part which enables disconnecting the weight at a top of the hole.

6. The system as in claim 2, wherein the hole is not completely vertical, and the stencil guides guide the weights to raise and lower in the nonvertical hole.

7. The system as in claim 1, wherein the hole includes at least one side shaft, at a bottom of the hole, extending nonvertical relative to the hole, and having structure for holding and storing at least one weight in the side shaft. and where the connection assembly enables removing the weight from the motor generator at a location of the side shaft to store the at least one weight in the side shaft.

8. The system as in claim 1, wherein the weights travel in the hole on cord shaped supports which can be raised, lowered and spooled.

9. The system as in claim 1, wherein the weights travel in the hole on rails.

10. The system as in claim 1, wherein the hole includes at least one side shaft at a bottom of the hole, the side shaft expend extending in a nonvertical direction at an angle relative to the shaft, and the hole having rounded corners at an area where the hole intersects with the side shaft, where the weights travel around the rounded corners into the nonvertical side shaft at a bottom portion of the hole.

11. The system as in claim 10, wherein the hole includes at least one side shaft at a top of the hole, the side shaft at the top of the hole extending in a nonvertical direction at an angle relative to the hole, and the hole having rounded corners where the hole meets the side shaft at the top of the hole, and where the weights travel around the rounded corners into the vertical side shaft at a top portion of the hole.

12. A method of storing power in positions of weights in a hole, comprising:
raising and lowering a plurality of weights in an underground hole, using a motor generator assembly, which is energized to raise at least one of the weights, thus storing potential energy in the position of the at least one of the weights, and which recovers energy from lowering the at least one of the weight as the at least one of the weight is lowered; and
connecting between the motor generator and a first weight to raise or lower the first weight,
disconnecting the first weight from the motor generator assembly after raising or lowering the weight;
after said disconnecting, attaching the motor generator to a second weight different from the first weight; and
using the motor generator to raise and lower the second weight after the first weight is disconnected.

13. The method as in claim 12, further comprising using a plurality of stencil guides in the hole, for guiding edge surfaces of the weights to raise and lower along specified paths through the holes defined by the stencil guides.

14. The method as in claim 13, further comprising disconnecting a weight at a bottom of the hole, to rest against a bottom surface of the hole, and be held upright and in position by the stencil guides.

15. The method as in claim 12, further comprising disconnecting a first weight at a bottom of the hole and storing the first weight at the bottom of the hole, and disconnecting a second weight at a top of the hole and storing the second weight at the top of the hole.

16. The method as in claim 12, wherein the hole includes at least one side shaft, at a bottom of the hole, extending nonvertical relative to the hole, and having structure for holding and storing at least one weight in the side shaft, and where the disconnecting comprises the first weight from the motor generator at the bottom of the hole to store the first weight in the side shaft at the bottom of the hole.

17. The method as in claim 12, wherein the hole includes at least one side shaft at a bottom of the hole, the side shaft expend extending in a nonvertical direction at an angle relative to the hole, and the hole having rounded corners at an area where the hole intersects with the side shaft, where the weights travel around the rounded corners into the nonvertical side shaft at a bottom portion of the hole.

18. The system as in claim 17, wherein the hole includes at least one side shaft at a top of the hole, the side shaft at the top of the hole extending in a nonvertical direction at an angle relative to the hole, and the hole having rounded corners, where the weights travel around the rounded corners into the vertical side shaft at a top portion of the hole.
